(19) United States
(12) Patent Application Publication
(10) Pub. No.: US 2012/0177951 A1
(43) Pub. Date: Jul. 12, 2012

(54) HEXAGONAL BARIUM FERRITE MAGNETIC PARTICLE AND METHOD OF MANUFACTURING THE SAME, AND MAGNETIC RECORDING MEDIUM

(75) Inventors: Nobuo YAMAZAKI, Minami-ashigara-shi (JP); Hiroyuki SUZUKI, Minami-ashigara-shi (JP)

(73) Assignee: FUJIFILM CORPORATION, Tokyo (JP)

(21) Appl. No.: 13/344,354

(22) Filed: Jan. 5, 2012

(30) Foreign Application Priority Data
Jan. 6, 2011 (JP) 2011-001329

(51) Int. Cl. G11B 5/706; H01F 1/11

(52) U.S. Cl. 428/842.8; 252/62.58

(57) ABSTRACT

An aspect of the present invention relates to a hexagonal barium ferrite magnetic particle, wherein, relative to 100 atom percent of a Fe content, an Al content ranges from 1.5 to 15 atom percent, a combined content of a divalent element and a pentavalent element ranges from 1.0 to 10 atom percent, an atomic ratio of a content of the divalent element to a content of the pentavalent element is greater than 2.0 but less than 4.0, and an activation volume ranges from 1,300 to 1,800 nm³.

### CROSS-REFERENCE TO RELATED APPLICATIONS

This application claims the benefit of priority under 35 USC 119 to Japanese Patent Application No. 2011-001329 filed on Jan. 6, 2011, which is expressly incorporated herein by reference in its entirety.

### BACKGROUND OF THE INVENTION

1. Field of the Invention

The present invention relates to a hexagonal barium ferrite magnetic particle and to a method of manufacturing the same. More particularly, the present invention relates to a hexagonal barium ferrite magnetic particle that is suitable as a magnetic material in magnetic recording media for high-density recording.

The present invention further relates to a magnetic recording-use magnetic powder comprised of the above hexagonal barium ferrite magnetic particle, and to a magnetic recording medium comprising the above hexagonal barium ferrite magnetic particle.

2. Discussion of the Background

Conventionally, primarily ferromagnetic metal particles have come to be employed in the magnetic layers of magnetic recording media for high density recording. Ferromagnetic metal magnetic particles are acicular particles comprised primarily of iron, and have come to be employed in magnetic recording media for various uses in which a reduction in particle size and high coercive force are sought in magnetic recording.

With an increase in the quantity of information being recorded has come a constant demand for high-density recording in magnetic recording media. However, in trying to achieve higher density recording, limits to the improvement of ferromagnetic metal magnetic particles have begun to appear. By contrast, hexagonal ferrite magnetic particles have a coercive force that is high enough for use in permanently magnetic materials, and a magnetic anisotropy, which is the basis of coercive force and is derived from a crystalline structure, that makes it possible to maintain high coercive force even when the size of magnetic particles is reduced. Further, magnetic recording media with magnetic layers in which hexagonal ferrite magnetic particles are employed afford good high-density characteristics due to their vertical component. Such hexagonal ferrite magnetic particles are ferromagnetic materials that are suited to higher densities. Thus, in recent years, various research has been conducted on magnetic recording media in which hexagonal ferrite magnetic particles are employed (for example, see Document 1 (Japanese Patent No. 3,251,753), Document 2 (Japanese Unexamined Patent Publication (KOKAI) No. 2002-260212), Document 3 (Japanese Unexamined Patent Publication (KOKAI) No. 2003-77116) or English language family members US2003/124386A1 and U.S. Pat. No. 6,770,359, and Document 4 (Japanese Unexamined Patent Publication (KOKAI) No. 2010-24113) or English language family member US2010/021771A1, which are expressly incorporated herein by reference in their entirety.

In recent years, recording has progressed to even higher densities. The recording density that is currently being targeted is 1 Gbpsi and above, even 10 Gbpsi and above, as a surface recording density. To achieve such high-density recording requires a reduction in the size of hexagonal ferrite magnetic particles to reduce noise. Thus, in Documents 1 to 4, studies have been made for the use of minute hexagonal ferrite magnetic particles.

However, as the size of the hexagonal ferrite magnetic particles decreases, the energy (magnetic energy) that maintains the magnetic orientation of the magnetic particles is unable to readily counter the thermal energy. The ability to retain recorded information ends up being reduced by so-called thermal fluctuation, and the phenomenon whereby the magnetic energy couldn't overcome the thermal energy and the recording is erased can no longer be ignored. In describing this point, “KuV/kT” is a known index of the thermal stability of magnetization. Ku is the anisotropy constant of the magnetic material, V is the volume of the particle (activation volume), k is the Boltzmann constant, and T is the absolute temperature. When the magnetic energy KuV increases relative to the thermal energy kT, the effect of thermal fluctuation can be inhibited. However, the particle volume V, that is, the particle size of the magnetic material, should be kept low to reduce medium noise, as set forth above. Thus, since the magnetic energy is the product of Ku and V, it suffices to increase Ku to achieve a high magnetic energy in the range where V is small. However, Ku is related to the anisotropic magnetic field HK by the relation HK=2Ku/Ms. Thus, when Ku is increased without a change in Ms, HK increases. The anisotropy magnetic field HK is the strength of the magnetic field that is required for saturation magnetization in the direction of the hard magnetization axis. When HK is high, the reversal of magnetization by the magnetic head tends not to occur, recording (the writing of information) becomes difficult, and reproduction output ends up dropping. That is, the higher the Ku of the magnetic particle, the more difficult it becomes to write information.

As set forth above, it is extremely difficult to satisfy all three characteristics of high density recording, thermal stability, and ease of writing. This is referred to as the “trilemma” of magnetic recording, and is becoming a major issue as the level of magnetization continues to rise.

### SUMMARY OF THE INVENTION

An aspect of the present invention provides for a means for solving the magnetic recording trilemma.

The present inventors conducted extensive research into achieving the above means.

First, to solve the trilemma, the present inventors conducted repeated research into finding a means of obtaining magnetic particles with an activation volume V of 1,300 to 1,800 nm³, a KuV/kT of equal to or greater than 60, and a saturation magnetization Gs of equal to or greater than 50 A·m²/kg. That is because the present inventors surmised that high-density recording could be achieved while maintaining thermal stability if the activation volume and KuV/kT were within the above ranges, and that the ease of writing could be ensured when V and KuV/kT were within the above-stated ranges when GS was equal to or greater than 50 A·m²/kg. As set forth above, when KuV was raised, it was possible to inhibit a drop in thermal stability, but the reversal of magnetization became difficult, resulting in difficulty of writing. An attempt was made to raise as to compensate for the above difficulty and thus ensure reproduction output. This point will be elaborated. Based on the above equation, it suffices to reduce HK to ensure the ease of writing while increasing Ku to increase the magnetization energy. To that end, it would be conceivable to increase Ms. Since Ms is the product of the saturation magnetization Gs and the specific gravity of the magnetic material, it is possible to increase Ms by increasing the us of the magnetic material.

Accordingly, the present inventors used a process of extensive trial and error on the elements constituting hexagonal ferrite magnetic particles, their contents, and their ratios. As a result, they discovered that hexagonal barium ferrite magnetic particles with an Al content of 1.5 to 15 atom percent relative to 100 atom percent of the Fe content, a combined content of a divalent element and a pentavalent element of 1.0 to 10 atom percent, an atomic ratio of the content of the divalent element to the content of the pentavalent element of greater than 2.0 but less than 4.0, and an activation volume falling within a range of 1,300 to 1,800 nm³ had good thermal stability and recording suitability in the high-density recording region.

The present invention was devised based on the above discovery.

An aspect of the present invention relates to a hexagonal barium ferrite magnetic particle, wherein, relative to 100 atom percent of a Fe content, an Al content ranges from 1.5 to 15 atom percent, a combined content of a divalent element and a pentavalent element ranges from 1.0 to 10 atom percent, an atomic ratio of a content of the divalent element to a content of the pentavalent element is greater than 2.0 but less than 4.0, and an activation volume ranges from 1,300 to 1,800 nm³.

The above hexagonal barium ferrite magnetic particle may have a saturation magnetization, as, of equal to or greater than 50 A·m²/kg.

The above hexagonal barium ferrite magnetic particle may have a thermal stability in the form of KuV/kT of equal to or greater than 60, wherein Ku denotes an anisotropy constant, V denotes an activation volume, k denotes a Boltzmann constant, and T denotes an absolute temperature.

The divalent element contained in the above hexagonal barium ferrite magnetic particle may be selected from the group consisting of Co and Zn.

The pentavalent element In the above hexagonal barium ferrite magnetic particle may be selected from the group consisting of V and Nb.

The above hexagonal barium ferrite magnetic particle may be employed for magnetic recording.

A further aspect of the present invention relates to a method of manufacturing a hexagonal barium ferrite magnetic particle, which comprises:

providing a starting material mixture wherein, relative to 100 atom percent of a Fe content, an Al content ranges from 1.5 to 15 atom percent, a combined content of a divalent element and a pentavalent element ranges from 1.0 to 10 atom percent, and an atomic ratio of a content of the divalent element to a content of the pentavalent element is greater than 2.0 but less than 4.0; and

conducting a glass crystallization method with the use of the starting material mixture to form the above hexagonal barium ferrite magnetic particle.

In the above method of manufacturing a hexagonal barium ferrite magnetic particle, the divalent element may be selected from the group consisting of Co and Zn.

In the above method of manufacturing a hexagonal barium ferrite magnetic particle, the pentavalent element may be selected from the group consisting of V and Nb.

A still further aspect of the present invention relates to a magnetic recording medium comprising a magnetic layer containing a ferromagnetic material and a binder on a nonmagnetic support, wherein the ferromagnetic material comprises the above hexagonal barium ferrite magnetic particle.

The present invention can resolve the trilemma of magnetic recording and permit even higher density recording.

Other exemplary embodiments and advantages of the present invention may be ascertained by reviewing the present disclosure and the accompanying drawing.

### BRIEF DESCRIPTION OF THE DRAWINGS

The present invention will be described in the following text by the exemplary, non-limiting embodiments shown in the figure, wherein:

FIG. 1 is a descriptive drawing (triangular phase diagram) showing an example of the composition of the starting material mixture.

FIG. 2 is a graph showing a plot of the activation volume V of the hexagonal barium ferrite magnetic particles of Examples and Comparative Examples against KuV/kT and saturation magnetization σs.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

An aspect of the present invention relates to a hexagonal barium ferrite magnetic particle, wherein, relative to 100 atom percent of a Fe content, an Al content ranges from 1.5 to 15 atom percent, a combined content of a divalent element and a pentavalent element ranges from 1.0 to 10 atom percent, an atomic ratio of a content of the divalent element to a content of the pentavalent element is greater than 2.0 but less than 4.0, and an activation volume ranges from 1,300 to 1,800 nm³.

The hexagonal barium ferrite magnetic particle of the present invention (also referred to simply as “magnetic particle”, hereinafter) is a microparticulate magnetic material capable of realizing a high SNR and achieving both thermal stability and recording suitability. Accordingly, the magnetic particle of the present invention is suitable as a magnetic recording-use magnetic powder, and among such powders, as the magnetic material of a magnetic recording medium for high-density recording.

The formula for simple barium ferrite is BaO.6Fe₂O₃. The ferrite composition is comprised of the three elements of Ba, Fe, and O. By contrast, the magnetic particle of the present invention contains, in addition to the Ba, Fe, and O that constitute ferrite, 1.5 to 15 atom percent of Al relative to 100 atom percent of the Fe content, a combined total of a divalent element and a pentavalent element of 1.0 to 10 atom percent relative to 100 atom percent of the Fe content, and the divalent element and the pentavalent element in an atomic ratio of the divalent element content to the pentavalent element content of greater than 2.0 but less than 4.0. Incorporating prescribed contents of divalent and pentavalent elements in the above ratio can raise as. However, divalent and pentavalent elements alone tend to lower Ku, compromising thermal stability. In this regard, the present inventors discovered that incorporating a prescribed quantity of Al into a system containing prescribed quantities of divalent and pentavalent elements in the above ratio could raise both as and Ku. The present invention was devised on that basis.

The magnetic particle of the present invention will be described in greater detail below.

The magnetic particle of the present invention comprises 1.5 to 15 atom percent of Al relative to 100 atom percent of the Fe content. As set forth above, the presence of Al can make it possible to raise both as and Ku. However, when Al is present in a quantity exceeding 15 atom percent, as tends to drop. At less than 1.5 atom percent, it becomes impossible to adequately raise Ku. From the perspective of achieving even further increases in as and Ku, the Al content in the magnetic particle of the present invention desirably falls within a range of 5.0 to 15 atom percent relative to 100 atom percent of the Fe content.

In addition to the above-stated quantity of Al, the magnetic particle of the present invention contains divalent and pentavalent elements in a combined quantity of 1.0 to 10 atom percent relative to 100 atom percent of the Fe content, with the atomic ratio of the divalent element content to the pentavalent element content being greater than 2.0 but less than 4.0. The divalent element content is also referred to below as the “M2+ quantity” and the pentavalent element content as the “M5+ quantity.” When the combined M2+ quantity and M5+ quantity is less than 1.0 atom percent relative to 100 atom percent of the Fe content, or when the atomic ratio [(M2+ quantity)/(M5+ quantity)] of the divalent element content to the pentavalent element content is equal to or less than 2.0, it becomes difficult to achieve an adequate as in the enhanced reproduction output. Additionally, when the combined M2+ quantity and M5+ quantity exceeds 10 atom percent relative to 100 atom percent of the Fe content, or when the atomic ratio [(M2+ quantity)/(M5+ quantity)] of the divalent element content to the pentavalent element content is equal to or greater than 4.0, the Ku enhancing effect of the Al ends up being canceled out, it becomes difficult to achieve a high Ku even when a prescribed quantity of Al is present, and thermal stability ends up decreasing. From the perspective of achieving even further increases in as and Ku, in the magnetic particle of the present invention, the combined M2+ quantity and M5+ quantity desirably falls within a range of 4.0 to 10 atom percent relative to 100 atom percent of the Fe content, and the atomic ratio [(M2+ quantity)/(M5+ quantity)] of the divalent element content to the pentavalent element content is desirably equal to or greater than 2.1 and equal to or less than 3.5.

The atomic ratio [(M2+ quantity)/(M5+ quantity)] of the divalent element content to the pentavalent element content will be described in greater detail. In methods of manufacturing hexagonal barium ferrite magnetic particles, the common practice is to adjust the composition so that the valence of the elements replacing the trivalent Fe in the barium ferrite is three. By contrast, the present inventors discovered that as was raised significantly by providing a rich quantity of divalent elements. To achieve a valence of three with divalent and pentavalent elements, the ratio [(M2+ quantity)/(M5+ quantity)] is 2.0. However, as can be significantly raised by employing a ratio exceeding 2.0 that is divalent rich. The reason for this is not necessarily clear. However, the present inventors presume it to be as follows. The up spin and down spin due to Fe sites is fixed in the crystal lattice of the barium ferrite, and as is known to result from the difference in the two. The substitution of divalent and pentavalent elements at Fe sites to achieve rich divalence is thought to facilitate a rise in as.

The above divalent element can be any element that imparts a divalent positive charge. From the perspective of raising as, this element is desirably selected from the group consisting of Co and Zn. The above pentavalent element can be any element that is capable of imparting a pentavalent positive charge. From the perspective of raising as, it is desirably selected from the group consisting of V and Nb. The present inventors surmise that when these elements are present in the contents and the ratio stated above as substitution elements of Fe (trivalent Fe) in the composition of ferrite, they contribute to raising σs.

According to the literature, the Ku of pure Ba ferrite (BaO.6Fe₂O₃) is 3.3E+5 J/m. Conventionally, the addition of substitution elements such as Co and Ti to pure barium ferrite is widely practiced to lower Ku. That is because, as set forth above, the higher Ku becomes, the more difficult recording becomes. By contrast, in the present invention, achieving both a rise in Ku and as makes it possible to ensure ease of writing in a magnetic material of high Ku. The magnetic particle of the present invention can be magnetoplumbite-type barium ferrite, magnetoplumbite-type ferrite in which the particle surface is covered with spinel, magnetoplumbite-type barium ferrite containing a partial spinel phase, and the like.

The contents and the ratio of the various elements in the magnetic particle of the present invention can be determined by a known elemental analysis method such as inductively coupled plasma (ICP) analysis. The magnetic particle of the present invention can be obtained by the glass crystallization method, described further below. In the glass crystallization method, nearly 100 percent of the quantities of Al, the divalent element, and the pentavalent element that are charged are present in the magnetic particle. Thus, the contents and the ratio can be calculated from the quantities that are charged.

By having the magnetic particle of the present invention be hexagonal barium ferrite magnetic particle containing Al, a divalent element, and a pentavalent element in the above-stated contents and ratio, and by having it be a microparticulate magnetic material with an activation volume falling within a range of 1,300 to 1,800 nm³, it becomes possible to reduce noise in the high-density recording region and achieve a high SNR. When the activation volume exceeds 1,800 nm³, it becomes difficult to reproduce with high sensitivity a signal that has been recorded at high density (the SNR drops). Additionally, when the activation volume is less than 1,300 nm³, it becomes difficult to achieve a magnetic energy KuV that can resist the thermal energy kT even when a high Ku is achieved, and the erasure of recordings by thermal fluctuation becomes a concern. Accordingly, from the perspective of simultaneously achieving thermal stability and a high SNR in the high-density recording region, the activation volume of the magnetic particles of the present invention falls within a range of 1,300 to 1,800 nm³.

Incorporating Al, a divalent element, and a pentavalent element in the above-stated quantities and the ratio into the magnetic particle of the present invention as set forth above makes it possible to achieve both high thermal stability and a high as. As stated above, for thermal stability, KuV/kT (Ku: anisotropy constant, V: activation volume, k: Boltzmann constant, T: absolute temperature) is desirably equal to or greater than 60. The magnetic particle of the present invention makes it possible to increase Ku within the range of microparticle having an activation volume V of 1,300 to 1,800 nm³, thereby increasing the magnetic energy KuV and achieving a KuV/kT of equal to or greater than 60. The higher KuV/kT is the better from the perspective of thermal stability. The upper limit is not specifically limited. For example, even at the high values of KuV/kT that are achieved with the Ku (3.3E+5 J/m, as stated above) of pure barium ferrite, the present invention makes it possible to ensure ease of writing by raising as, as set forth above.

As described above, Ku can be controlled by the quantity of Al. V can be controlled by the magnetic particle manufacturing conditions. For example, when the magnetic particle of the present invention is manufactured by the glass crystallization method, the activation volume of the magnetic particle can be controlled through the crystallization conditions.

As set forth above, the saturation magnetization as of the magnetic particle of the present invention is desirably equal to or greater than 50 A·m²/kg. From the perspectives of inhibiting the noise accompanying reproduced signals and the saturation of GMR reproduction heads, it is generally thought sufficient for as to not be excessively high. For that reason, an upper limit of about 60 A·m²/kg, for example, can be set for as. However, from the perspectives of recording characteristics and reproduction output, the higher as is, the better. Accordingly, by optimizing the system and the like to inhibit the above noise and head saturation, it is possible to employ magnetic particles having a higher as and achieve even better recording characteristics and reproduction output.

Saturation magnetization as can be controlled by means of the contents and the ratio of the divalent element and pentavalent element, as described above.

So long as the magnetic particle of the present invention is as set forth above, the method used to manufacture it is not specifically limited. A known method of manufacturing barium ferrite magnetic particles, such as the glass crystallization method, the water hot synthesis method, and the coprecipitation method, can be employed to manufacture the magnetic particle of the present invention. However, the glass crystallization method is desirable employed to readily obtain the above-described microparticulate magnetic particle.

That is, the present invention relates to a method of manufacturing (also referred to simply as the “method of manufacturing a magnetic particle”, hereinafter) the hexagonal barium ferrite magnetic particle of the present invention by the glass crystallization method.

The method of manufacturing the magnetic particle of the present invention yields the hexagonal barium ferrite magnetic particle of the present invention by the glass crystallization method employing a starting material mixture wherein, relative to 100 atom percent of a Fe content, an Al content ranges from 1.5 to 15 atom percent, a combined content of divalent elements and pentavalent elements ranges from 1.0 to 10 atom percent, and an atomic ratio of a content of divalent elements to a content of pentavalent elements is greater than 2.0 but less than 4.0.

As set forth above, since it is possible to obtain barium ferrite containing nearly 100 percent of the Al, divalent element, and pentavalent element charged as starting materials in the glass crystallization method, using the above starting material mixture makes it possible to obtain the hexagonal barium ferrite magnetic particle of the present invention with a 1.5 to 15 atom percent content of Al relative to 100 atom percent of the Fe content, a combined content of divalent elements and pentavalent elements of 1.0 to 10 atom percent, an atomic ratio of the divalent element content to the pentavalent element content of greater than 2.0 and less than 4.0, and an activation volume falling within a range of 1,300 to 1,800 nm³. The activation volume can be controlled through the crystallization conditions as set forth above; the details will be described further below.

The method of manufacturing a magnetic particle of the present invention yields a hexagonal barium ferrite magnetic particle by the glass crystallization method, as set forth above. The glass crystallization method is generally comprised of the following steps:

(1) a step of melting a starting material mixture comprising a hexagonal ferrite-forming component (and an optional coercive force-adjusting component) and a glass-forming component to obtain a melt (melting step);
(2) a step of quenching the melt to obtain an amorphous material (amorphous rendering step);
(3) a step of heat treatment of the amorphous material to cause hexagonal ferrite particles to precipitate in a product obtained by the heat treatment (crystallization step); and
(4) a step of subjecting the heat treated product to treatment with an acid and washing to collect hexagonal ferrite magnetic particles (particle collecting step).

In the method of manufacturing a hexagonal ferrite magnetic particle of the present invention, a starting material mixture containing Fe, Al, a divalent element, and a pentavalent element in the above-stated contents and the ratio can be used as the starting material mixture employed in step (1). From it, hexagonal ferrite magnetic particles and crystallized glass components can be precipitated in step (3). Subsequently, in step (4), acid treatment and washing can be conducted to collect hexagonal ferrite magnetic particles containing Fe, Al, a divalent element, and a pentavalent element in the above-stated contents and ratio.

The method of manufacturing a hexagonal ferrite magnetic particle of the present invention will be described in greater detail below.

### (1) Melting Step

The starting material mixture employed in the glass crystallization method contains a glass-forming component and a hexagonal ferrite-foaming component. A starting material mixture containing at least Fe, Al, a divalent element, and a pentavalent element in the contents and the ratio indicated above is employed in the present invention. The term “glass-forming component” refers to a component that is capable of exhibiting a glass transition phenomenon to form an amorphous material (vitrify). A B₂O₃ component is normally employed as a glass-forming component in the glass crystallization method. In the present invention, it is possible to employ a starting material mixture containing a B₂O₃ component as the glass-forming component. In the glass crystallization method, the various components contained in the starting material mixture are present in the form of oxides or various salts that can be converted to oxides in a step such as melting. In the present invention, the term “B₂O₃ component” includes B₂O₃ itself and various salts, such as H₃BO₃, that can be changed into B₂O₃ in the process. The same holds true for other components. Examples of glass-forming components other than B₂O₃ components are SiO₂ components, P₂O₅ components, and GeO₂ components.

The hexagonal ferrite-forming component contained in the starting material mixture contains an Fe₂O₃ component and a BaO component as components constituting barium ferrite magnetic powder. The combined content of the hexagonal ferrite (barium ferrite)-forming components in the starting material mixture can be suitably established based on the desired magnetic characteristics. The present inventors surmise that in the method of manufacturing a magnetic particle of the present invention, the introduction of a divalent element and a pentavalent element as substitution elements for Fe is desirable from the perspective of raising σs. Accordingly, the divalent element and pentavalent element are desirably added as components that replace a portion of the Fe₂O₃ component in the form of oxides or in the form of various salts (hydroxides, or the like) that can be converted into oxides in the melting step or the like.

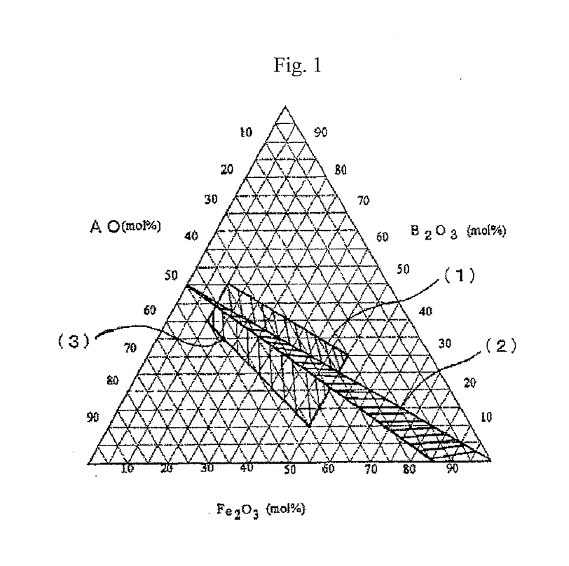

With the exception that the composition of the starting material mixture contains the contents and the ratio of Al, a divalent element, and a pentavalent element set forth above, it is not specifically limited. In the method of manufacturing the magnetic particle of the present invention, Al can be added in the form of an oxide or in the form of various salts (hydroxides, or the like) that can be converted into oxides in the melting step or the like. In the triangular phase diagram shown in FIG. 1, with an AO component (in the formula, A denotes Ba), a B₂O₃ component, and an Fe₂O₃ component as the vertices, the starting materials within the composition region of hatched portions (1) to (3) are desirable compositions of the starting material mixture for obtaining magnetic particles having good magnetic characteristics. In the method of manufacturing a magnetic particle of the present invention, a portion of the AO component, B₂O₃ component, and Fe₂O₃ component can be replaced with an Al compound, divalent element compound, and pentavalent compound.

The above starting material mixture can be obtained by weighing out and mixing the various components. Then, the starting material mixture is melted to obtain a melt. The melting temperature can be set based on the starting material composition, normally, to 1,000 to 1,500° C. The melting time can be suitably set for suitable melting of the starting material mixture.

### (2) Amorphous Rendering Step

Next, the melt that is obtained is quenched to obtain a solid. The solid is an amorphous material in the form of glass-forming components that have been rendered amorphous (vitrified). The quenching can be carried out in the same manner as in the quenching step commonly employed to obtain an amorphous material in glass crystallization methods. For example, a known method can be conducted, such as a quenching rolling method in which the melt is poured onto a pair of water-cooling rollers being rotated at high speed.

### (3) Crystallization Step

Following quenching, the amorphous material obtained is heat treated. This step causes hexagonal ferrite magnetic particles and crystallized glass components to precipitate. The size of the hexagonal barium ferrite magnetic particles that precipitate can be controlled by means of the heating temperature and the heating time for crystallization. In the pulverization processing and coating liquid dispersion processing described further below, the particle size of the hexagonal barium ferrite magnetic particle does not change. Accordingly, the crystallization temperature and heating time are desirably determined to finally yield hexagonal barium ferrite magnetic particles having an activation volume of 1,300 to 1,800 nm³ in the present invention. Although the crystallization temperature also depends on the starting material composition, it is desirably equal to or higher than 600° C. and equal to or lower than 750° C. The heating time for crystallization (the period of maintenance at the above crystallization temperature) is, for example, 0.5 to 24 hours, desirably 1 to 8 hours. A suitable rate of temperature rise to the crystallization temperature is, for example, 0.2 to 10° C./minute.

### (4) Particle Collecting Step

Hexagonal barium ferrite magnetic particles and crystallized glass components precipitate into the heat treated product that has been subjected to a heat treatment in the crystallization step. Accordingly, subjecting the heat treated product to an acid treatment can cause the crystallized glass components that are surrounding the particles to dissolve out, making it possible to collect the hexagonal barium ferrite magnetic particles.

Prior to the acid treatment, it is desirable to conduct pulverization processing to enhance the efficiency of the acid treatment. Coarse pulverization can be conducted by either a dry or wet method. However, from the perspective of achieving uniform pulverization, a wet method is desirable. The pulverization processing conditions can be set according to a known method, or reference can be made to Examples set forth further below. The acid treatment to collect the particles can be conducted by a method that is generally conducted in the glass crystallization method, such as an acid treatment with heating. Reference can be made to Examples set forth further below. Subsequently, if necessary, the product can be subjected to washing with water, drying, and other post-processing to obtain the hexagonal barium ferrite magnetic particle of the present invention.

The magnetic recording medium of the present invention comprises a magnetic layer containing a ferromagnetic material and a binder on a nonmagnetic support. It comprises the hexagonal barium ferrite magnetic particle of the present invention as the above ferromagnetic material. As set forth above, the hexagonal barium ferrite magnetic particle of the present invention makes it possible to achieve the three characteristics of high density recording, thermal stability, and ready writing, thereby resolving the trilemma and further advancing high-density recording.

The magnetic recording medium of the present invention will be described in greater detail below.

### Magnetic Layer

Details of the hexagonal barium ferrite magnetic particle employed in the magnetic layer, and the method of manufacturing the particle, are as set forth above. In addition to the hexagonal barium ferrite magnetic particle, the magnetic layer comprises a binder. Examples of the binder comprised in the magnetic layer are: polyurethane resins; polyester resins; polyamide resins; vinyl chloride resins; styrene; acrylonitrile; methyl methacrylate and other copolymerized acrylic resins; nitrocellulose and other cellulose resins; epoxy resins; phenoxy resins; and polyvinyl acetal, polyvinyl butyral, and other polyvinyl alkyral resins. These may be employed singly or in combinations of two or more. Of these, the desirable binders are the polyurethane resins, acrylic resins, cellulose resins, and vinyl chloride resins. These resins may also be employed as binders in the nonmagnetic layer described further below. Reference can be made to paragraphs [0029] to [0031] in Japanese Unexamined Patent Publication (KOKAI) No. 2010-24113, which is expressly incorporated herein by reference in its entirety, for details of the binder. A polyisocyanate curing agent may also be employed with the above resins.

Additives can be added as needed to the magnetic layer. Examples of these additives are abrasives, lubricants, dispersing agents, dispersion adjuvants, antifungal agents, antistatic agents, oxidation-inhibiting agents, solvents, and carbon black. The additives set forth above may be suitably selected for use based on desired properties in the form of commercial products or those manufactured by the known methods. Reference can also be made to paragraph [0033] in Japanese Unexamined Patent Publication (KOKAI) No. 2010-24113 for details of the carbon black.

### Nonmagnetic Layer

Details of the nonmagnetic layer will be described below. The magnetic recording medium of the present invention may comprise a nonmagnetic layer comprising a nonmagnetic powder and a binder between the nonmagnetic support and the magnetic layer. Both organic and inorganic substances may be employed as the nonmagnetic powder in the nonmagnetic layer. Carbon black may also be employed. Examples of inorganic substances are metals, metal oxides, metal carbonates, metal sulfates, metal nitrides, metal carbides, and metal sulfides. These nonmagnetic powders are commercially available and can be manufactured by the known methods. Reference can be made to paragraphs [0036] to [0039] in Japanese Unexamined Patent Publication (KOKAI) No. 2010-24113 for details thereof.

Binder resins, lubricants, dispersing agents, additives, solvents, dispersion methods, and the like suited to the magnetic layer may be adopted to the nonmagnetic layer. In particular, known techniques for the quantity and type of binder resin and the quantity and type of additives and dispersing agents employed in the magnetic layer may be adopted thereto. Carbon black and organic powders can be added to the magnetic layer. Reference can be made to paragraphs [0040] to [0042] in Japanese Unexamined Patent Publication (KOKAI) No. 2010-24113 for details thereof.

### Nonmagnetic Support

A known film such as biaxially-oriented polyethylene terephthalate, polyethylene naphthalate, polyamide, polyamidoimide, or aromatic polyamide can be employed as the nonmagnetic support. Of these, polyethylene terephthalate, polyethylene naphthalate, and polyamide are preferred.

These supports can be corona discharge treated, plasma treated, treated to facilitate adhesion, heat treated, or the like in advance. The center average roughness, Ra, at a cutoff value of 0.25 mm of the nonmagnetic support suitable for use in the present invention preferably ranges from 3 to 10 nm.

### Layer Structure

As for the thickness structure of the magnetic recording medium of the present invention, the thickness of the nonmagnetic support preferably ranges from 3 to 80 μm. The thickness of the magnetic layer can be optimized based on the saturation magnetization of the magnetic head employed, the length of the head gap, and the recording signal band, and is normally 10 to 150 nm, preferably 20 to 120 nm, and more preferably, 30 to 100 nm. At least one magnetic layer is sufficient. The magnetic layer may be divided into two or more layers having different magnetic characteristics, and a known configuration relating to multilayered magnetic layer may be applied.

The nonmagnetic layer is, for example, 0.1 to 3.0 μm, preferably 0.3 to 2.0 μm, and more preferably, 0.5 to 1.5 μm in thickness. The nonmagnetic layer of the magnetic recording medium of the present invention can exhibit its effect so long as it is substantially nonmagnetic. It can exhibit the effect of the present invention, and can be deemed to have essentially the same structure as the magnetic recording medium of the present invention, for example, even when impurities are contained or a small quantity of magnetic material is intentionally incorporated. The term “essentially the same” means that the residual magnetic flux density of the nonmagnetic layer is equal to or lower than 10 mT, or the coercive force is equal to or lower than 7.96 kA/m (equal to or lower than 100 Oe), with desirably no residual magnetic flux density or coercive force being present.

### Backcoat Layer

A backcoat layer can be provided on the surface of the nonmagnetic support opposite to the surface on which the magnetic layer are provided, in the magnetic recording medium of the present invention. The backcoat layer desirably comprises carbon black and inorganic powder. The formula of the magnetic layer or nonmagnetic layer can be applied to the binder and various additives for the formation of the back layer. The back layer is preferably equal to or less than 0.9 μm, more preferably 0.1 to 0.7 μm, in thickness.

### Manufacturing Method

The process for manufacturing magnetic layer, nonmagnetic layer and backcoat layer coating liquids normally comprises at least a kneading step, a dispersing step, and a mixing step to be carried out, if necessary, before and/or after the kneading and dispersing steps. Each of the individual steps may be divided into two or more stages. All of the starting materials employed in the present invention, including the ferromagnetic material, nonmagnetic powder, binders, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. Details of the kneading process are described in Japanese Unexamined Patent Publication (KOKAI) Heisei Nos. 1-106338 and 1-79274. The contents of these applications are incorporated herein by reference in their entirety. Further, glass beads may be employed to disperse the magnetic layer, nonmagnetic layer and backcoat layer coating liquids. Dispersing media with a high specific gravity such as zirconia beads, titania beads, and steel beads are also suitable for use. The particle diameter and filling rate of these dispersing media can be optimized for use. A known dispersing device may be employed. Reference can be made to paragraphs [0051] to [0057] in Japanese Unexamined Patent Publication (KOKAI) No. 2010-24113 for details of the method of manufacturing a magnetic recording medium.

The magnetic recording medium of the present invention is suitable as a high-density recording-use magnetic recording medium of which good electromagnetic characteristics are demanded because it can achieve a high SNR in the high recording density region and a high reproduction output by incorporating the hexagonal barium ferrite magnetic particle of the present invention.

### EXAMPLES

The present invention will be described in detail below based on Examples. However, the present invention is not limited to Examples. The terms “parts” and “percent” given in Examples are weight parts and weight percent unless specifically stated otherwise.

1. Examples and Comparative Examples of the Hexagonal Barium Ferrite Magnetic Particles

A starting material formula was determined based on the composition of Table 1 based on a starting material composition of 35.2 mol percent BaO, 29.4 mol percent of B₂O₃, and 35.4 mol percent of Fe₂O₃, with a portion of the Fe being replaced with the oxides of divalent and pentavalent elements and a portion of the B₂O₃ being replaced with Al₂O₃. The total quantity of starting materials was 2 kg.

The various components were weighed out to obtain the starting material formula that had been determined and mixed in a mixer to obtain a starting material mixture. The starting material mixture that was obtained was melted in a one-liter platinum crucible. While being stirred at 1,380° C., an outlet provided on the bottom of the platinum crucible was heated and the melt was discharged in rod form at about 6 g/sec. The discharged liquid was quenched and rolled with a pair of water-cooled rolls to fabricate amorphous materials A to P.

Each of the amorphous materials obtained was charged in a quantity of 300 g to an electric furnace, the temperature was raised at 5° C./minute to the crystallization temperature indicated in Table 2, and maintained at the crystallization temperature for five hours to cause hexagonal barium ferrite magnetic particles to precipitate (crystallize). Next, the crystallized product containing the hexagonal barium ferrite magnetic particles was coarsely pulverized in a mortar. To a 2,000 mL glass bottle were added 1,000 g of Zr beads 1 mm in diameter and 800 mL of a 1 percent concentration of acetic acid, and the mixture was dispersed for three hours in a paint shaker. The dispersion was separated from the beads and charged to a three-liter stainless steel beaker. The dispersion was treated for three hours at 100° C., precipitated with a centrifugal separator, repeatedly decanted, washed, and dried, yielding magnetic particles (Nos. 1 to 24). The magnetic particles obtained were analyzed by X-ray diffraction to confirm that they were hexagonal ferrite (barium ferrite).

2. Examples and Comparative Examples of the Magnetic Recording Medium (Magnetic Tape)

2-1. Formula of Magnetic Layer Coating Liquid

Hexagonal barium ferrite magnetic particles (listed in Table 3): 100 parts

Polyurethane resin: 12 parts

Weight average molecular weight 10,000

Sulfonic acid function group content 0.5 meq/g

Diamond microparticles (average particle diameter 50 nm): 2 parts

Carbon black (#55 made by Asahi Carbon, particle size: 0.015 μm): 0.5 part

Stearic acid: 0.5 part

Butyl stearate: 2 parts

Methyl ethyl ketone: 180 parts

Cyclohexanone: 100 parts

2-2. Nonmagnetic Layer Coating Liquid

Nonmagnetic power α-iron oxide: 100 parts

Average primary particle diameter: 0.09 μm

Specific surface area by BET method: 50 m²/g

pH: 7

DBP oil absorption capacity: 27 to 38 g/100 g

Surface treatment agent: Al₂O₃, 8 weight percent

Carbon black (Conductex SC-U made by Columbian Chemicals): 25 parts

Vinyl chloride copolymer (MR104 made by Zeon Corp.): 13 parts

Polyurethane resin (UR8200 made by Toyobo): 5 parts

Phenylphosphonic acid: 3.5 parts

Butyl stearate: 1 part

Stearic acid: 2 parts

Methyl ethyl ketone: 205 parts

Cyclohexanone: 135 parts

2-3. Fabrication of Magnetic Tape

The various components of each of the above coating liquids were kneaded in kneaders. Horizontal sand mills were charged with a quantity of zirconia beads 1.0 mm in diameter that filled 65 percent of the volume of the dispersing element thereof, the liquids were passed through the sand mills with pumps, and dispersion was conducted for 120 minutes (actual period of residence in the dispersing element) at 2,000 rpm. In the case of the nonmagnetic layer coating liquid, 6.5 parts of polyisocyanate were added to the dispersion obtained. Additionally, 7 parts of methyl ethyl ketone were added. The mixtures were then filtered using filters having an average pore diameter of 1 μm to prepare a nonmagnetic layer coating liquid and a magnetic layer coating liquid, respectively.

Sequential multilayer coating was conducted by coating and drying the nonmagnetic layer coating liquid that had been obtained to a dry thickness of 1.0 μm on a polyethylene naphthalate base 5 μm thickness, and then applying a magnetic layer 70 nm in thickness thereover. After drying, processing was conducted with a seven-stage calender at a temperature of 90° C. and a linear pressure of 300 kg/cm. The product was slit to ¼ inch width and subjected to a surface polishing treatment, yielding magnetic tapes (Nos. 1 to 5).

3. Evaluation of the Magnetic Particles and Magnetic Tapes

The magnetic particles and magnetic tapes were evaluated by the following methods. All of the evaluations were conducted by measurement in an environment of 23° C.±1° C. In the present invention, the activation volume V, anisotropy constant Ku, and KuV/kT refer to values measured by these present methods.

### (1) Magnetic Characteristics (Hc, σs)

The magnetic characteristics of magnetic particle Nos. 1 to 23 in Table 1 were measured at a magnetic field strength of 1,194 kA/m (15 kOe) with a vibrating sample fluxmeter (made by Toei-Kogyo Co., Ltd.).

### (2) Specific Surface Area SSA

The specific surface areas of Nos. 1 to 23 shown in Table 1 were obtained by the BET method.

### (3) Output, Noise, SNR

The reproduction output, noise, and SNR of each of magnetic tape Nos. 1 to 5 in Table 3 were measured after mounting a recording head (MIG, gap 0.15 μm, 1.8 T) and reproduction GMR head on a drum tester and recording a signal at a track density of 16 KTPI and a linear recording density of 400 Kbpi (surface recording density 6.4 Gbpsi).

### (4) Demagnetization

Magnetic tape Nos. 1 to 5 in Table 3 were saturation magnetized at 1,194 kA/m (15 kOe) with a vibrating sample fluxmeter (made by Toei-Kogyo Co., Ltd.). The magnetic field polarity was changed and a 500 Oe reverse magnetic field was applied. The demagnetization was calculated using the following equation from the levels of magnetization at 0 seconds and at 60 seconds.

Demagnetization (%)=1-(level of magnetization after 60 s/level of magnetization after 0 s)×100

### (5) Activation Volume, Anisotropy Constant, Thermal Stability KuV/kT

Measurement was conducted using a vibrating sample fluxmeter (made by Toei-Kogyo Co., Ltd.) at magnetic field sweep rates of the Hc measurement element of 3 minutes and 30 minutes, and the activation volume V and anisotropy constant Ku were calculated from the relational equation of Hc due to thermal fluctuation and the magnetization reversal volume below.

Hc=2Ku/Ms{1−[(KuT/kV)ln(At/0.693)]1/2}

(In the equation, Ku: anisotropy constant; Ms: saturation magnetization; k: Boltzmann constant; T: absolute temperature; V: activation volume; A: spin precession frequency; t: magnetic field reversal time)

The details of the starting material formulas of the magnetic particles set forth above are given in Table 1. The crystallization temperatures during the preparation of the magnetic particles and the evaluation results of the magnetic particles prepared are given in Table 2. And the details of the magnetic tapes prepared are given in Table 3.

TABLE 1

| | | | | | | (M2+ quantity) + | |
|---|---|---|---|---|---|---|---|
| | | Type of | | Type of | | (M5+ quantity) | |
| Amorphous | Al/Fe | divalent | M2+/Fe | pentavalent | M5+/Fe | atomic % relative | M2+/M5+ |
| material | atomic % | element (M2+) | atomic % | element (M5+) | atomic % | to Fe | at % |
| A | 0.00 | Not incorporated | 0.00 | Not incorporated | 0.00 | 0.00 | 0.00 |
| B | 5.20 | Not incorporated | 0.00 | Not incorporated | 0.00 | 0.00 | 0.00 |
| C | 5.20 | Zn | 3.00 | Nb | 1.00 | 4.00 | 3.00 |
| D | 1.50 | Zn | 0.70 | Nb | 0.30 | 1.00 | 2.33 |
| E | 1.00 | Zn | 0.70 | Nb | 0.30 | 1.00 | 2.33 |
| F | 15.00 | Zn | 7.00 | Nb | 3.00 | 10.00 | 2.33 |
| G | 17.00 | Zn | 7.00 | Nb | 3.00 | 10.00 | 2.33 |
| H | 5.20 | Zn | 3.00 | Nb | 1.43 | 4.43 | 2.10 |
| I | 15.00 | Zn | 8.00 | Nb | 3.00 | 11.00 | 2.67 |
| J | 5.20 | Zn | 3.00 | Nb | 1.50 | 4.50 | 2.00 |
| K | 5.20 | Zn | 4.00 | Nb | 1.00 | 5.00 | 4.00 |
| L | 5.20 | Zn | 4.20 | Nb | 1.00 | 5.20 | 4.20 |
| M | 5.20 | Co | 3.00 | Nb | 1.00 | 4.00 | 3.00 |
| N | 5.20 | Zn | 3.00 | V | 1.00 | 4.00 | 3.00 |
| O | 0.00 | Zn | 3.00 | Nb | 1.50 | 4.50 | 2.00 |
| P | 8.00 | Zn | 6.00 | Nb | 2.50 | 8.50 | 2.40 |

TABLE 2

| | | | | Saturation | Coercive | | | |
|---|---|---|---|---|---|---|---|---|
| Magnetic | | | Crystallization | magnetization | force | Activation | Anisotropy | Thermal |
| material | | Amorphous | temperature | σ₂s | Hc | volume V | constant Ku | stability |
| No | | material | ° C. | A · m²/kg | kA/m | nm³ | E + 5 J/m | KuV/kT |
| 1 | Comp. Ex. | A | 640 | 41.8 | 156 | 1470 | 1.48 | 52.7 |
| 2 | Comp. Ex. | A | 680 | 43.7 | 201 | 1710 | 1.66 | 68.4 |
| 3 | Comp. Ex. | A | 720 | 44.9 | 245 | 1800 | 1.69 | 73.7 |
| 4 | Comp. Ex. | B | 680 | 47.8 | 279 | 1580 | 1.89 | 72.3 |
| 5 | Comp. Ex. | B | 700 | 48.7 | 309 | 1770 | 1.93 | 82.5 |
| 6 | Comp. Ex. | B | 720 | 50.0 | 338 | 1970 | 1.97 | 93.5 |
| 7 | Example | C | 660 | 50.3 | 208 | 1450 | 1.70 | 60.1 |
| 8 | Example | C | 680 | 51.1 | 231 | 1560 | 1.73 | 65.3 |
| 9 | Example | C | 700 | 51.8 | 256 | 1730 | 1.74 | 72.9 |
| 10 | Example | D | 690 | 50.5 | 239 | 1800 | 1.73 | 75.3 |
| 11 | Comp. Ex. | E | 690 | 46.6 | 229 | 1790 | 1.70 | 73.6 |
| 12 | Example | F | 700 | 53.0 | 299 | 1350 | 1.90 | 62.0 |
| 13 | Comp. Ex. | F | 680 | 47.0 | 259 | 1250 | 1.79 | 54.0 |
| 14 | Comp. Ex. | G | 700 | 39.6 | 310 | 1350 | 1.93 | 63.0 |
| 15 | Example | H | 680 | 54.0 | 242 | 1600 | 1.74 | 67.2 |
| 16 | Comp. Ex. | I | 700 | 57.0 | 171 | 1350 | 1.54 | 50.2 |
| 17 | Comp. Ex. | J | 680 | 48.0 | 227 | 1500 | 1.70 | 61.5 |
| 18 | Example | K | 680 | 51.8 | 217 | 1500 | 1.67 | 60.5 |
| 19 | Comp. Ex. | L | 680 | 52.0 | 173 | 1500 | 1.55 | 56.0 |
| 20 | Example | M | 680 | 51.3 | 241 | 1550 | 1.74 | 65.1 |
| 21 | Example | N | 680 | 51.3 | 241 | 1550 | 1.74 | 65.1 |
| 22 | Comp. Ex. | O | 680 | 51.1 | 207 | 2120 | 1.43 | 73.0 |
| 23 | Comp. Ex. | O | 630 | 44.6 | 167 | 1750 | 1.32 | 56.0 |
| 24 | Example | P | 700 | 58.9 | 257 | 1720 | 1.78 | 74.1 |

TABLE 3

| | | Magnetic | | | | Demag- |
|---|---|---|---|---|---|---|
| Medium | | material | Output | Noise | SNR | netization |
| No | | No | dB | dB | dB | % |
| 1 | Comp. Ex. | 22 | 0 | 0 | 0 | 5 |
| 2 | Comp. Ex. | 23 | −1.2 | −2.1 | 0.9 | 15 |
| 3 | Comp. Ex. | 3 | −4 | −2.8 | −1.2 | 2 |
| 4 | Example | 10 | 0.8 | −1.7 | 2.5 | 2 |
| 5 | Example | 12 | −0.1 | −3.2 | 3.1 | 4 |
| 6 | Comp. Ex. | 13 | −3.5 | −3.6 | 0.1 | 18 |

Evaluation Results

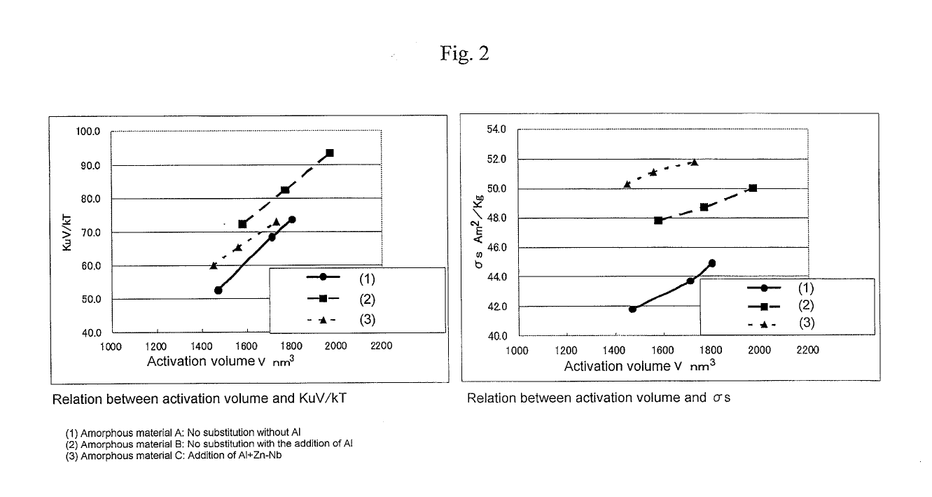

FIG. 2 is a graph showing the measured activation volume V, KuV/kT, and as of each of magnetic material Nos. 1 to 9 of Table 2. Magnetic material Nos. 1 to 3 obtained from amorphous material A were unsubstituted barium ferrite. Unsubstituted barium ferrite has conventionally been considered to exhibit a higher Ku than substituted barium ferrite prepared by replacing a portion of the Fe. However, for a reason that is unclear, magnetic material Nos. 4 to 6, obtained from amorphous material B to which Al was added, exhibited a higher Ku than magnetic material Nos. 1 to 3, which were unsubstituted barium ferrite. Accordingly, a comparison of particles exhibiting similar activation volumes revealed that in magnetic material Nos. 4 to 6, KuV/kT was higher than in magnetic material Nos. 1 to 3. Magnetic material Nos. 4 to 6 exhibited higher levels of rs than magnetic material Nos. 1 to 3. However, σs of equal to or higher than 50 A·m²/kg was not achieved in the microparticle region targeted by the present invention. Magnetic material Nos. 7 to 9, obtained from amorphous material C, were Examples of the present invention to which Al was added and in which Fe was substituted by Zn and Nb. Substitution with Zn—Nb resulted in a lower Ku than when just Al was added in magnetic material Nos. 4 to 6, but one that was higher than in magnetic material Nos. 1 to 3, which were unsubstituted barium ferrite. Accordingly, a comparison of particles exhibiting similar activation volumes revealed that magnetic material Nos. 7 to 9 exhibited a higher KuV/kT than magnetic material Nos. 1 to 3. Additionally, magnetic material Nos. 7 to 9 attained rs of equal to or higher than 50 A·m²/kg in the microparticle region. Such a decrease in KuV/kT and an increase in σs by the substitution of Zn—Nb were attributed to the replacement of a portion of the Fe in the barium ferrite.

Media Nos. 4 and 5 in Table 3 are magnetic tapes fabricated using the magnetic materials of the Examples shown in Table 2. They exhibited better SNRs and better recording retention (less demagnetization) than the media of the comparative examples shown in Table 3 (media Nos. 1 to 3 and 6). By contrast, the reason why medium No. 1 exhibited a poor SNR was thought to be that the magnetic material employed had an activation volume exceeding 1,800 nm³. Medium No. 2 is a comparative example showing that a medium with good thermal stability (recording retention) and recording characteristics could not be obtained by simply reducing the size of the particles in the magnetic material. Medium No. 3 is a comparative example showing that poor recording characteristics were obtained despite obtaining good thermal stability (recording retention) with conventional unsubstituted barium ferrite. Medium No. 6 is a comparative example showing that it was difficult to obtain a medium affording both thermal stability and ease of writing in the high-density recording region with microparticles having an activation volume of less than 1,300 nm³.

The results set forth above indicate that the present invention yields a magnetic recording medium that satisfies the three characteristics of a density recording, thermal stability, and ease of writing. That is, the present invention can resolve the trilemma of magnetic recording.

The present invention can provide a magnetic recording medium for high-density recording that exhibits good recording and reproduction characteristics.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A hexagonal barium ferrite magnetic particle, wherein, relative to 100 atom percent of a Fe content, an Al content ranges from 1.5 to 15 atom percent, a combined content of a divalent element and a pentavalent element ranges from 1.0 to 10 atom percent, an atomic ratio of a content of the divalent element to a content of the pentavalent element is greater than 2.0 but less than 4.0, and an activation volume ranges from 1,300 to 1,800 nm³.

2. The hexagonal barium ferrite magnetic particle according to claim 1, which has a saturation magnetization, as, of equal to or greater than 50 A·m²/kg.

3. The hexagonal barium ferrite magnetic particle according to claim 1, which has a thermal stability in the form of KuV/kT of equal to or greater than 60, wherein Ku denotes an anisotropy constant, V denotes an activation volume, k denotes a Boltzmann constant, and T denotes an absolute temperature.

4. The hexagonal barium ferrite magnetic particle according to claim 1, wherein the divalent element is selected from the group consisting of Co and Zn.

5. The hexagonal barium ferrite magnetic particle according to claim 1, wherein the pentavalent element is selected from the group consisting of V and Nb.

6. The hexagonal barium ferrite magnetic particle according to claim 1, which is employed for magnetic recording.

7. A method of manufacturing a hexagonal barium ferrite magnetic particle, which comprises:
providing a starting material mixture wherein, relative to 100 atom percent of a Fe content, an Al content ranges from 1.5 to 15 atom percent, a combined content of a divalent element and a pentavalent element ranges from 1.0 to 10 atom percent, and an atomic ratio of a content of the divalent element to a content of the pentavalent element is greater than 2.0 but less than 4.0; and
conducting a glass crystallization method with the use of the starting material mixture to form the hexagonal barium ferrite magnetic particle according to claim 1.

8. The method of manufacturing a hexagonal barium ferrite magnetic particle according to claim 7, wherein the divalent element is selected from the group consisting of Co and Zn.

9. The method of manufacturing a hexagonal barium ferrite magnetic particle according to claim 7, wherein the pentavalent element is selected from the group consisting of V and Nb.

10. The method of manufacturing a hexagonal barium ferrite magnetic particle according to claim 7, wherein the hexagonal barium ferrite magnetic particle formed has a saturation magnetization, σs, of equal to or greater than 50 A·m²/kg.

11. The method of manufacturing a hexagonal barium ferrite magnetic particle according to claim 7, wherein the hexagonal barium ferrite magnetic particle formed has a thermal stability in the form of KuV/kT of equal to or greater than 60, wherein Ku denotes an anisotropy constant, V denotes an activation volume, k denotes a Boltzmann constant, and T denotes an absolute temperature.

12. A magnetic recording medium comprising a magnetic layer containing a ferromagnetic material and a binder on a nonmagnetic support, wherein
the ferromagnetic material comprises the hexagonal barium ferrite magnetic particle according to claim 1.

13. The magnetic recording medium according to claim 12, wherein the hexagonal barium ferrite magnetic particle contained in the magnetic layer has a saturation magnetization, as, of equal to or greater than 50 A·m²/kg.

14. The magnetic recording medium according to claim 12, wherein the hexagonal barium ferrite magnetic particle contained in the magnetic layer has a thermal stability in the form of KuV/kT of equal to or greater than 60, wherein Ku denotes an anisotropy constant, V denotes an activation volume, k denotes a Boltzmann constant, and T denotes an absolute temperature.

15. The magnetic recording medium according to claim 12, wherein the divalent element contained in the hexagonal barium ferrite magnetic particle is selected from the group consisting of Co and Zn.

16. The magnetic recording medium according to claim 12, wherein the pentavalent element contained in the hexagonal barium ferrite magnetic particle is selected from the group consisting of V and Nb.
